(19) United States
(12) Patent Application Publication
(10) Pub. No.: US 2015/0278739 A1
(43) Pub. Date: Oct. 1, 2015

(54) MEASURING UTILISATION OF PHYSICAL LOCATIONS

(71) Applicant: THE ROYAL BANK OF SCOTLAND PLC, Edinburgh (GB)

(72) Inventors: Gregory John Parker, London (GB); Richard John Latimir, London (GB)

(21) Appl. No.: 14/434,608

(22) PCT Filed: Feb. 28, 2013
(86) PCT No.: PCT/EP2013/054110

§ 371 Date: Apr. 9, 2015

(30) Foreign Application Priority Data
Oct. 10, 2012 (GB) 1218189.7

(51) Int. Cl. G06Q 10/06

(52) U.S. Cl. CPC G06Q 10/06315

(57) ABSTRACT

Examples of at least one or more of an apparatus, computer-implemented method and system are described for measuring the utilisation of a plurality of physical locations. In one example an occupancy processor is arranged to analyse one or more network connection sessions to determine a network device that is being physically accessed by a user. An interface may be communicatively coupled to the occupancy processor. The interface may be arranged to receive data indicative of a physical location of said network device, said data being derived from a mapping of data indicative of said network device to data indicative of a physical location of said network device and said mapping being based on network infrastructure data. The occupancy processor is then further arranged to determine at least one occupancy metric for a plurality of physical locations based on data received from said interface.

### TECHNICAL FIELD

The present invention relates to a system and method for measuring the utilisation of physical locations using data associated with one or more network devices.

### BACKGROUND

It is often desired to make efficient use of the physical space available in a building. With a growing urban population, physical space is limited and must be used wisely. Organisations also grow and shrink but buildings are often designed, built or rented at fixed points in time, meaning the actual utilisation of a building rarely matches an initial planned value.

Making efficient use of space is also an effective solution for reducing energy usage. For example, a building may house a varying number of employees but heating and ventilation systems may be set up using estimates derived in a planning stage. Variations between estimated and actual utilisation lead either to unworkable environmental conditions or temporary and inefficient solutions, such as an increased use of gas heating or electric air conditioning. Likewise, lighting and security systems are often set to default values that can waste energy.

WO2008030889 describes a space management system and method. The described space management system analyses the utilisation of a space by one or more persons. The space management system includes a data collector configured to collect information output by an identifier such as a radio-frequency identification device (RFID) distributed in or around the space. The information indicates presence of the one or more persons in the space. The data collector is further configured to store occupancy data for the space based on the collected information. A data analyser coupled to the data collector is configured to generate a graphical report or user interface based on the occupancy data. The graphical report or user interface displays an indication of a percentage of time the space was occupied during a period of time and/or a graphical indicator based on the percentage of time the space was occupied during the period of time and the number of persons present in the space during the period of time.

### BRIEF DESCRIPTION OF THE DRAWINGS

FIG. 1A is a schematic illustration of a user seated at a workstation.

FIG. 1B is a schematic illustration of a user seated at a workstation with a thin client connection to a virtual machine host.

FIG. 1C is a schematic illustration of a user seated at a workstation with a thin client having a brokered connection to a virtual machine host.

FIG. 1D is a schematic illustration of a user logged onto the workstation having a remote connection to another workstation.

FIG. 1E is a schematic illustration of a user connected to a workstation from an external source.

FIG. 1F is a schematic illustration of a user connected to a virtual machine host from an external source.

FIG. 2A is a schematic illustration of a user logged on to a workstation having remote connections to a virtual machine host and other workstation.

FIG. 2B is a schematic illustration of an example of two users both having access to the same workstation at the same time with the first user in an idle session.

FIG. 2C is a schematic illustration of a second user remotely connecting to a virtual machine host and other workstation in an active session.

FIG. 2D is a schematic illustration of a user remotely connecting through a virtual machine host to access the sessions of other workstations.

FIG. 2E is a schematic illustration of a user remotely connecting to other workstations to access the sessions of the workstations remotely or through a virtual machine host.

FIG. 3A is a schematic illustration of network data according to a first example that may be used with the described examples.

FIG. 3B is a schematic illustration of further network data according to a first example that may be used with the described examples to determine a network connection method.

FIG. 3C is a schematic illustration of network data according to a second example that may be used with the described examples.

FIG. 3D is a schematic illustration of further network data according to a second example that may be used with the described examples to determine a network connection method.

FIG. 4 is a schematic illustration of a system for measuring utilisation of physical locations.

FIG. 5 is a first screenshot of an exemplary output generated by certain described examples.

FIG. 6 is a second screenshot of an exemplary output generated by certain described examples.

### DETAILED DESCRIPTION

According to one aspect of the described examples an apparatus for measuring the utilisation of a plurality of physical locations is provided comprising: an occupancy processor arranged to analyse one or more network connection sessions to determine a network device that is being physically accessed by a user; an interface communicatively coupled to the occupancy processor and arranged to receive data indicative of a physical location of said network device, said data being derived from a mapping of data indicative of said network device to data indicative of a physical location of said network device, said mapping being based on network infrastructure data, wherein the occupancy processor is further arranged to determine at least one occupancy metric for a plurality of physical locations based on data received from said interface.

In certain examples, the occupancy processor is arranged to analyse one or more network connection sessions to determine a session state based on network data indicating one or more of a log-in and lock status for a network device, said session state being used to determine said at least one occupancy metric. Data indicative of a network connection method may comprise determining, from remote connection data, a network device that is being physically accessed by a user. A network connection session may involve a remote network connection.

In certain examples the apparatus comprises a database storing data associated with a user of a network, wherein the system is arranged to correlate a user of a network device analysed by the occupancy processor with data in said database for use in outputting a set of utilisation measurements for the plurality of physical locations.

The plurality of physical locations may be associated with internal and/or external areas of at least one building and the at least one occupancy metric may be used to generate a set of utilisation measurements for each physical location.

In certain examples the apparatus operates at a predetermined frequency to generate a set of utilisation measurements for the plurality of physical locations over one or more time periods.

According to one aspect of the described examples a computer-implemented method to determine the usage of physical space comprises: identifying a first set of network devices; resolving a plurality of network connection sessions associated with the first set of network devices, wherein said resolving comprises determining a second set of network devices that are physically accessed by a corresponding plurality of users; determining a plurality of session states associated with the second set of network devices; processing at least data indicative of said session states to generate data indicative of at least one utilisation metric for the second set of network devices; mapping identification data for the second set of network devices to data indicative of one or more physical locations within said physical space, wherein said mapping comprises resolving one or more physical network connections in a network infrastructure; and integrating said data indicative of at least one utilisation metric and said data indicative of one or more physical locations to output a set of utilisation metrics associated with said one or more physical locations, said set of utilisation metrics corresponding to at least an occupancy of a physical location by one or more users.

The method may comprise at least one of determining if a network device from the first set of network devices is being accessed locally by a user and determining if a network device from the first set of network devices is associated with a remote network connection. Determining a session state may comprise at least one of: determining a lock status of a network device and determining a log-in status of a network device. Resolving a plurality of network connection sessions may comprise resolving a virtual machine hostname to a network device.

According to one aspect of the described examples a system for measuring the utilisation of a plurality of physical locations comprises a first component for mapping data indicative of one or more network-enabled computing devices to data indicative of one or more physical locations in said plurality of physical locations based on network connection data associated with said one or more network devices, a second component for receiving an output of the first component and determining a status of one or more network connection sessions involving said one or more network devices and a third component for receiving an output of at least one of the first component and the second component and outputting a set of utilisation measurements for the plurality of physical locations.

In certain examples the second component is arranged to analyse one or more network connection sessions to determine a session state based on network data for a network device, said session state being used to determine at least one occupancy metric that forms part of the set of utilisation measurements. The second component may also be arranged to determine, from remote connection data, a network device that is being physically accessed by a user.

Any of the aspects and modifications described above may make use of features of other aspects and modifications in any combination.

Certain examples described herein optimise the use of desk space and workstations within an organisation across one or more national and/or global locations. This has an advantage of allowing the organisation to easily assess their use of physical space and allows for efficiencies through appropriate use of that space.

An organisation may have a requirement to assess the utilisation of desk space across one or more buildings to improve the management and analysis of end user building occupancy. Such analysis is intended to determine, amongst other, one or more of: under\over utilisation of specific buildings, network management, environmental system management, optimisation strategies for existing locations, planning future expansion requirements, departmental resource allocation

A number of approaches and technologies have been discussed to accurately and efficiently capture actual desk usage ranging from regular manual audits to automated optical detection. Other existing systems also collect data from identifiers or sensors, such as RFIDs, distributed around a space. Desk booking systems also exist that allow a user to book the use of a particular desk. In these cases a desk may be booked by a user via, for example, a web or kiosk user interface.

In certain examples described herein it is proposed that one potential method uses the principle that workstation activity, i.e. measured properties of a networked device, can be correlated to user occupancy for any given location.

An easily managed and implemented solution is proposed that functions to assess the on-going usage of desk space and workstations within an organisation in a clear and efficient way. This enables the organisation to obtain an accurate overview of the activities for which space, i.e. one or more physical locations and/or areas associated with one or more buildings, is used and aids strategy and development with relation to said space. The one or more physical locations and/or areas may be within at least one building and/or may relate to outdoor and external locations and/or areas. In this description the term “physical location” will be used to refer to one or more of a point location, a range of point locations, an area, a range of areas, a volume and a range of volume and will be used synonymously with the term “space”. For example, a physical location may represent a particular physical area or volume that envelopes a particular desk or work environment.

Certain examples are applicable to organisations having a plurality of physical locations distributed nationally and/or globally. Certain examples limit the need for onerous hardware-based methods of managing space, for example card swipes, radio frequency tag tracking and/or visual/optical monitoring, and provides an advantageous solution that may be implemented with minimal disruption to existing infrastructure, whilst allowing the use of one or more physical locations to be easily understood and reviewed through the use of graphical displays to display measurements that are generated. Certain examples make use of existing network devices without the need for specialised hardware devices such as sensors or identifiers. This avoids problems with battery-life, sensor calibration, false-positives from non-users etc. Certain examples provide an improved measurement device for determining the utilisation and occupancy of a physical location that may be constructed using existing network infrastructure.

By monitoring the activities for which the space is being used over an extended period of time, it is possible to identify work areas that are overused and have limited scope for further use, or areas that have light workloads and so have room for expansion of work related activities. Likewise, different environmental controls may be set for work areas that are overused, for example heating due to the presence of many human beings may reduce the need for artificial heat sources such as gas heating, and/or areas that are underused may be more efficiently filled with occupants in line with reducing the need for artificial heat sources. An ability to assess the use of space in this way can greatly contribute towards efficiencies, whether they relate to, amongst others, energy, utilisation, spatial and/or cost, in the running of the organisation nationally and/or across a global scale.

Certain examples additionally allow for space management in the form of managing remote network use, for example home-based working using virtual connectivity or ‘hot-desking’. Further efficiency can be found using these examples by optimally allocating work space, for example for booking space for meetings and/or ‘hot desk’ booking For example certain examples may be coupled to desk booking systems to present under- or un-used space for a user to book. As certain examples described herein determine utilisation and occupancy based on the use of network devices they provide a more accurate record of actual use when compared to systems that use manually-entered booking data.

Certain examples use network data to provide details of all network devices on a given network, for example all internet protocol (IP) devices on a given network (or set of networks). These examples may then determine how the IP devices are connected to the network. For example, it can be determined whether the IP devices are directly connected, wirelessly connected, or are virtual devices (e.g. are instances of a virtual machine on a server). In addition, in some examples it can be determined if an IP device is connected from outside a particular building or location (as would be the case for a home worker for example). It is further possible to identify the type of IP device such as, but not limited to, a laptop, desktop, smartphone or tablet computer and to identify how long the IP devices have been connected to the network to determine an active or inactive mode or session. This information may be gained from one or more servers or processors that are arranged to monitor a network infrastructure. Network data may comprise one or more of data at a physical, data-link, network, transport or session layer.

Certain examples provide a solution that enables a network infrastructure to collate data and provide a detailed measurement of the use of physical locations and IP devices over a desired period of time in conjunction with user details. The representation of the data analysed can be customised to enable an operator to assess the use of said locations in terms of, amongst others, one or more of the following: which employees work in each work area; the time period for which each work area is in use on a daily basis; where the IP devices are located and/or which employees access them; and the use of space at any given time or extended time period.

In one example, one or more of the following data sets are gathered and analysed to determine the usage of space within a building, such as for a desktop or desk or workstation:
A mapping of one or more workstations, e.g. data identifiers indicative of said one or more workstations to data indicative of desk location.
A connection method to one or more workstations. To infer that a desk is in use, a workstation session must typically be accessed locally by a user (a console session) or the device must be actively being used to remote to another machine. This may comprise a resolution of a virtual machine hostname to a physical thin client or a desktop computer hostname.
A session state of one or more workstations. If a workstation is unlocked on a console session, the desk will be deemed to be actively in use and occupied. If a workstation is logged on but locked and it is not hosting a remote session, the desk can be considered in use but not occupied.

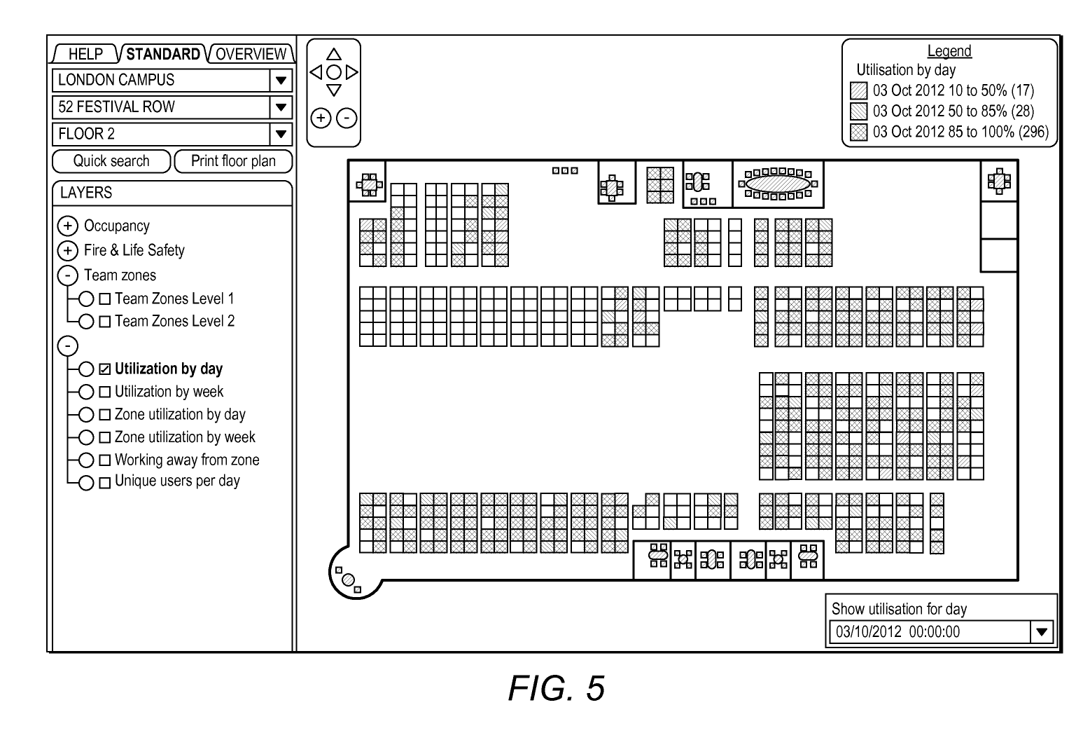

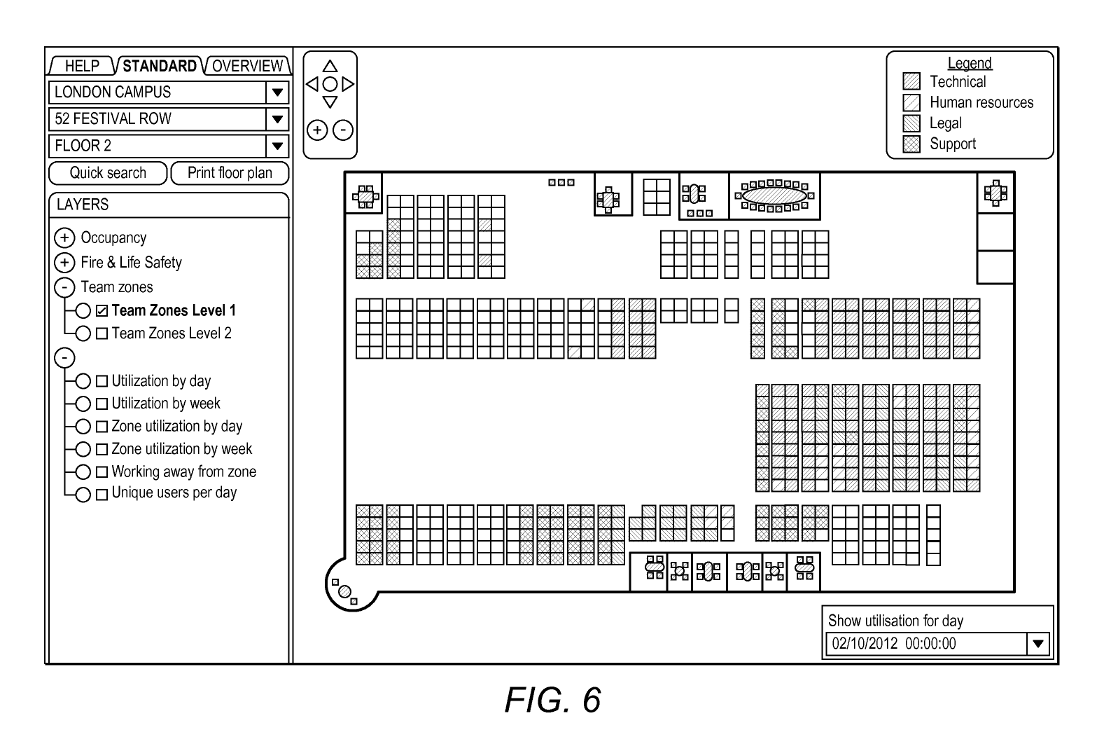

In one example, one or more of the following systems and/or technologies are utilised to obtain and aggregate data as described above:
A first component, for example implemented using a programmed computer, which manages cabling infrastructure and patching of one or more workstations, can provide desk location information for workstations. This apparatus may be implemented using an intelligent infrastructure management system such as an iPatch intelligent infrastructure system manufactured by CommScope Incorporated of Hickory North Carolina. It may have access to a cabling infrastructure database that is used to locate a device to a desk. Once initialised with infrastructure data, it allows a determination of what devices are connected to the network and where they are located.
A second component, for example implemented using a programmed computer, which provides user workstation connection information. This may be an application running on a computer such as a server. For example, this may comprise a network application that manages remote network connections and virtual machine operations. It may also provide session state information. This component may record the details of the user that is logged in to each network device and if it is actively in use (logged on and unlocked) or dormant (logged off or locked). It also provides network connection method data which is used for tracing remote and external source sessions (home workers etc.).
A third component comprising a database of further data used in reporting. For example it may comprise staff records to determine a user-to-department mapping. It may be an Electronic Communications Database (ECD).
A reporting and analysis component, which may be web-based, for processing and aggregating data from at least one of the three components above. This may be a Consolidated Inventory Database which processes session state data generated by the second component, location data from the first component and desk allocation data from an ECD. This component may be arranged to produce an aggregated view of the data that is used to generate displays such as the ‘heat map’-type outputs shown in FIGS. 5 and 6.

An advantage of this approach includes automated sampling. For example, the apparatus described above need not require agents to be installed on individual machines. It also allows it to scale easily and adapt to change. For example, the components may be implemented by adapting existing systems to perform the communication and processing described herein. The system also enables the examples to operate with so-called “bring-your-own-devices”: smartphones and tablets; devices that a network management system may have limited control over. This provides better data accuracy and eliminates ongoing allocation of resources for manual surveys. The frequency of sampling intervals can be adjusted to provide any required level of granularity. Elements of this system may utilise existing technologies in a new manner to reduce development and implementation effort.

The system may be deployed on one or more of a Microsoft Windows®, Linux® and Solaris® computer platform. The computer platform may comprise one or more data networks. It may make use of one or more databases. These databases may comprise a Structured Query Language (SQL) and/or Oracle® database.

Certain examples described herein relate to a concept of desk usage. Desk usage is defined as a correlation between a given session state of usage of a workstation and an indication of whether an individual is seated at that desk location or not. Certain examples involve analysis of one or more of session states and connection types to determine desk usage. This enables occupancy to be established, “occupancy” meaning that a given location is actively being used by an individual who is seated at a workstation located at a given desk, e.g. that a user is physically present in a given location and is physically (as opposed to remotely) accessing said workstation. Certain examples described herein also enable workstations that are not actively in use but are deemed to be used by an individual to be accounted for. For example, an individual uses a particular area of desk space may temporarily attend meetings in a given day, be on leave or be in attendance at another site.

It should be noted that a given workstation could have two concurrent valid user connections if remote network connections are in use, e.g. using remote desktop and/or virtual network computing protocols. For example, there may be multiple concurrent user sessions on any one particular network device. These user sessions may also comprise a mixture of local and remote sessions. This complexity has made it difficult to accurately determine if a user is actually physically present at a given workstation.

Certain examples herein determine a session state. A session state may be determined for a particular set of network devices. Once determined an interpretation of a session state indicates whether a desk is being used and if it is occupied by an individual. In one case this is determined at least in part on whether the workstation session is locked or unlocked. Although in this case other system activity such as mouse movement is not used, it may be used in other examples to complement existing data.

For example, in one implementation a session state may be determined by remotely analysing a lock status and/or a log-in status of a workstation. Status data indicating one or more of a lock status and a log-in status may be retrieved from a network management application or accessed from data output by a network management application. In one example, for a particular analysed workstation, data indicative of an “active” session state may be recorded if data associated with the workstation indicates that a user is logged into the workstation and the workstation is unlocked, for example as determined by the absence of an operating system lock screen. In this case, an “idle” session state may be recorded if data associated with the workstation indicates that a user is logged into the workstation and the workstation is locked, for example as determined by the presence of an operating system lock screen. The presence and/or absence of an operating system or hardware-implemented (e.g. on a thin client) lock screen may be either remotely determined using a network query or retrieved from a network management application. Finally, in this case, an “inactive” session state may be recorded if data associated with the workstation indicates that a user is not logged into the workstation. Other session states and/or session state criteria may be used in different implementations.

To better understand certain examples herein a number of different network connection methods will be described. These are provided as examples only and actual implementations may comprise network connection methods that combine, remove and/or add elements of the examples. The examples are provided as an indication of the complexity of network connections that may arise. One or more of these network connection methods may be determined by systems described herein and used to generate at least one utilisation metric.

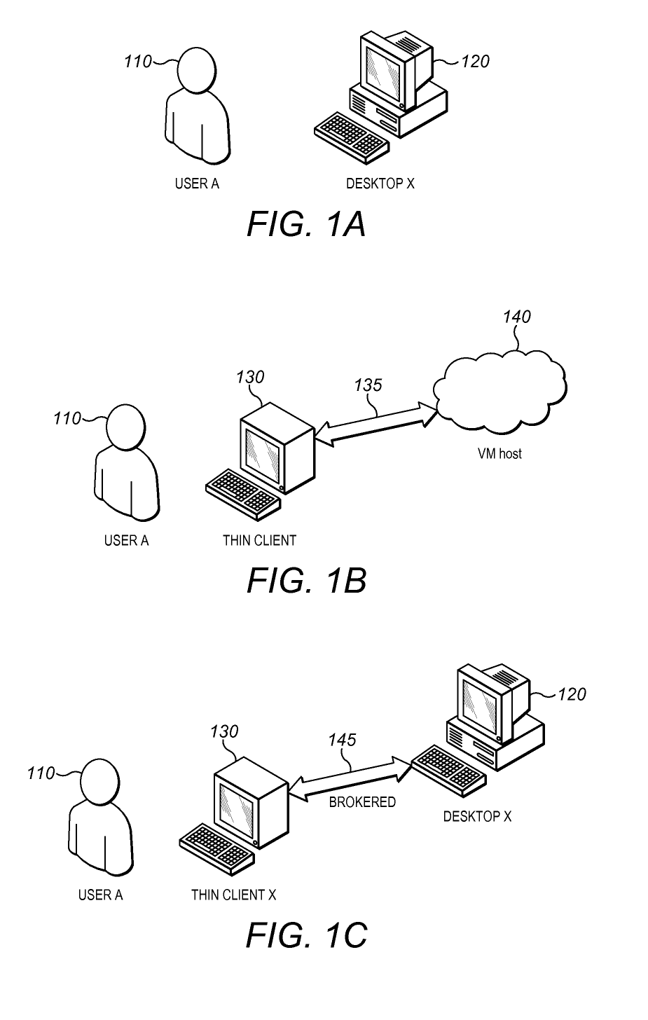

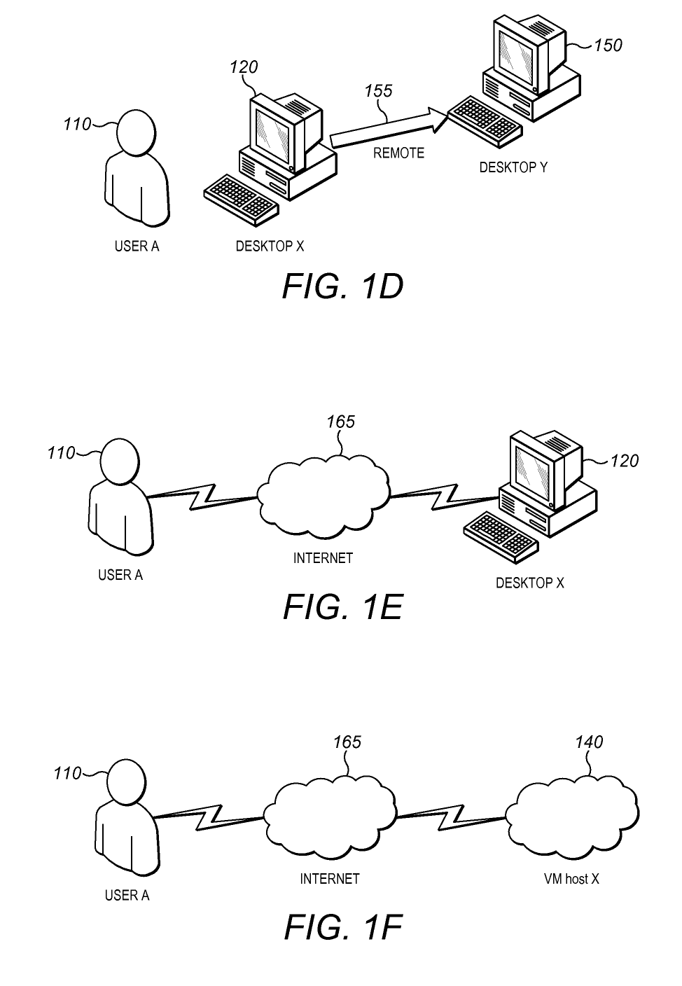

FIG. 1A shows an individual or user 110 who is seated at a workstation 120 at a given desk and the user 110 is logged onto the workstation 120. In this example, the workstation comprises a desktop personal computer. There is no remote connection attributed with this session. If the user 110 is actively using the workstation 120 then the session state is unlocked and the workstation 120 is active. The desk or location is said to be occupied by the user 110.

FIG. 1B shows a user 110 seated at a workstation comprising a thin client 130 with a network connection 135 to a virtual machine host 140. The network connection may be a remote or local connection. In this case, the network connection method may be detected by a system for assessing utilisation by reading the thin client hostname, which may a unique identifier for a particular network device, and/or one or more of an IP address and a MAC address. The thin client hostname may appear as a network connection attribute (referred to herein as a “VIA” attribute, e.g. a display or application is provided ‘via’ a particular network connection) in a system component that manages remote connections, which in all the examples herein may comprise the second component described above and below.

FIG. 1C shows a brokered connection 145 between a thin client 130 and a workstation 120. In this example, the workstation 120 is a desktop personal computer. In this case a user 110 may be seated at the thin client 130 but does not have a connection with a virtual machine host. In this case, the network connection method may be identified by examining a VIA attribute in a system component that manages remote connections. In this case workstation 120 would have an associated VIA attribute that is set to the hostname of the thin client 130.

FIG. 1D shows a user 110 logged onto the workstation 120 having a remote connection 155 to another workstation 150. In this case both workstations are desktop personal computers. The other workstation 150 has a VIA attribute set to the user's workstation 120, which may be used to identify a network connection method representative of the remote desktop connection 155. This means that the session of the other workstation 150 is linked with the user's workstation 120, and the session state of the other workstation 150 and the location of the user's workstation 120 are combined.

As shown in FIGS. 1E and 1F, it must be possible for a system component that manages remote connections to show that a user 110 working from home can either be connected to their workstation 120, or to a virtual machine host 140 from an external source 165, such as the internet.

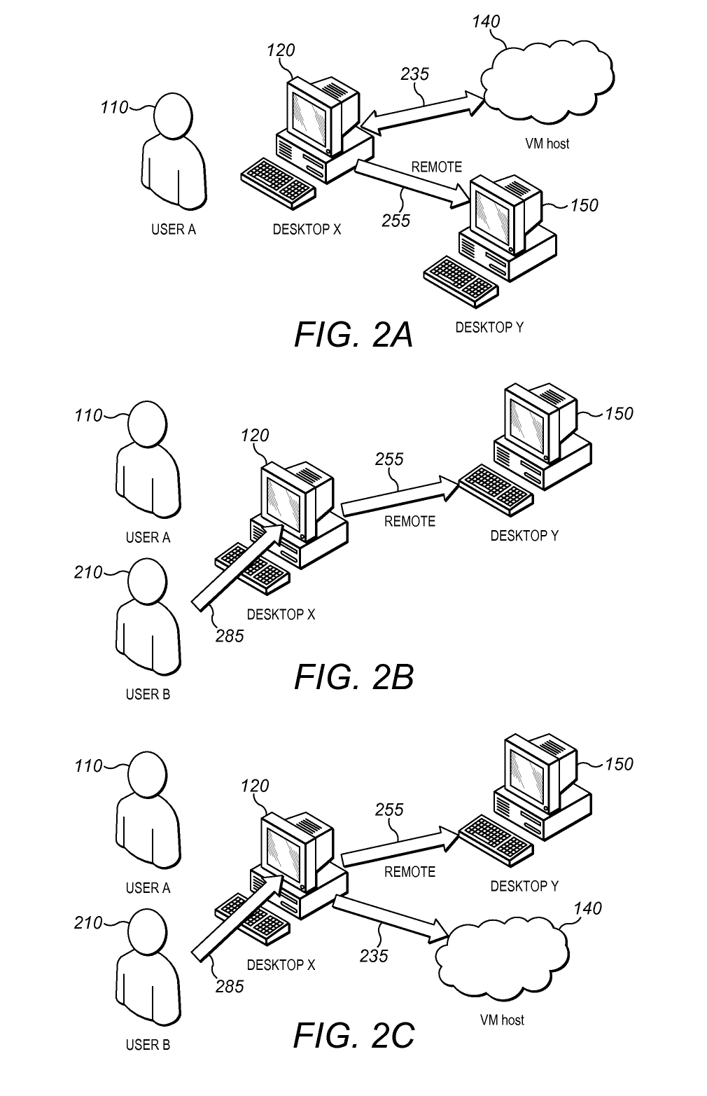

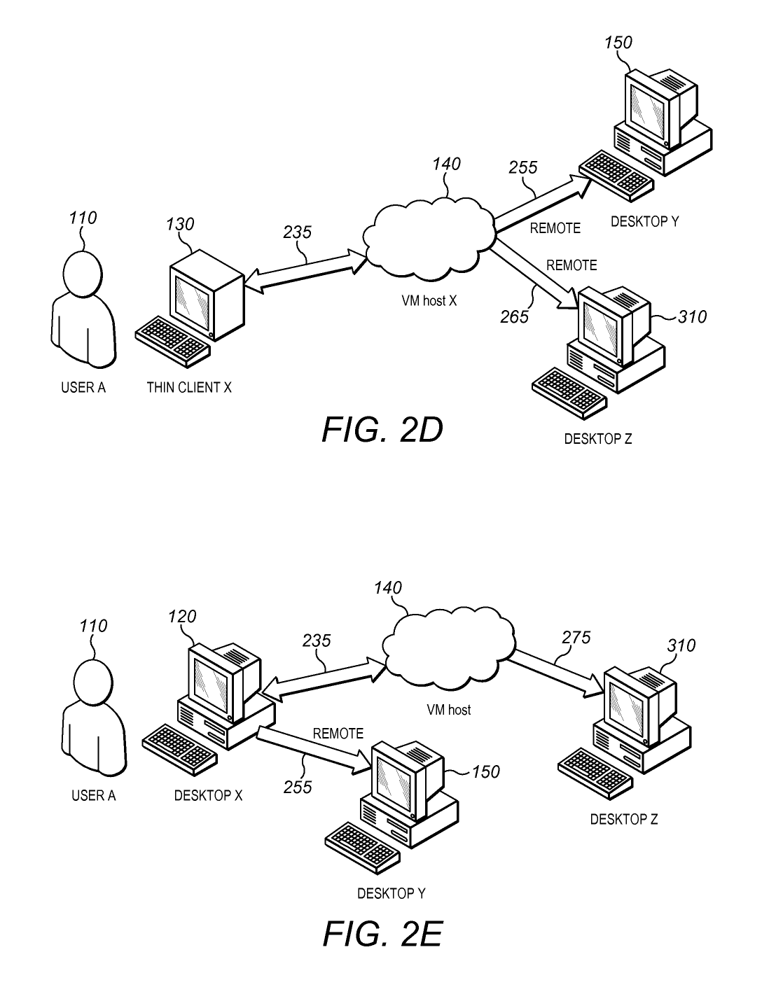

FIGS. 2A to 2E show a number of more complex network connection methods. These may comprise combinations of any of the previously described connections. In general, to determine a network connection method a series of one or more VIA, i.e. network connection, attributes may be iteratively analysed. For example to resolve a network device such as a workstation that is physically accessed by a user the presently described system may need to iteratively trace a chain of network connections.

For example, if a host has a VIA reference (which may comprise a VIA attribute) to another host, the latter host may be analysed to determine if it also has a VIA reference. In certain cases, it may itself have a VIA reference to a third device. The third device may then be analysed. This is iteratively repeated until a particular device or host is established to be a console or originating host. This process can be repeated any number of times and applied to any of the previously described connection types until the beginning of the chain is found.

FIG. 2A shows a user 110 that is logged on to a workstation 120 and remotely connects 235 to a virtual machine host 140, and also connects 255 to another workstation 150. The virtual machine host 140 and the other workstation 150 both have a VIA attribute comprising the hostname of workstation 120. This attribute may be read to determine the network connection method. In this case, there will be multiple sessions for the hostname of the workstation 120, and each session can be active or idle (depending on whether the workstation 120 is in an unlocked, or locked state respectively).

It is also possible for two users to both access a workstation 120 at the same time, as shown in FIGS. 2B and 2C. In this example, multiple remote sessions occur at the same time. In FIG. 2B, a first user 110 is logged onto the workstation 120 but has locked the workstation 120. The session of the workstation 120 is therefore idle and the first user is not seated at the desk of the workstation 120. Following this, a second user 210 is seated at the desk of the workstation 120 and has logged onto the workstation 120, such that the session of the workstation 120 is unlocked and active. This demonstrates how there may be chains of network connections and multiple user sessions associated with each node in the chain. For example, at a lock screen of workstation 120 a particular graphical control element and/or key sequence may unlock the workstation 120 for a parallel session. The second user 210 remotely connects 255 to the other workstation 150 (in FIG. 2B) and/or the virtual machine host 140 (in FIG. 2C). The other workstation 150 (and any further remotely connected workstations if present) and the virtual machine have the same VIA attribute of the workstation 120. The second user 210 is actively using the connection and is in an active state. The second user 210 is therefore considered to be occupying the desk (and workstation 120). The first user 110 does not occupy the desk and is in an idle session state.

FIG. 2D shows a user 110 connected 235 to a virtual machine host from a thin client 130. The user 110 is then able to remotely connect 255, 265 from the virtual machine host 140 to both of the workstations 150, 310, which in this example are desktop computing devices. The location of the thin client 130 needs to be known for each workstation 150, 310 in order to determine whether the session is being accessed locally by the user 110 or if it is being accessed remotely. The workstations 150, 310 each have a VIA attribute of the virtual machine host 140, and the virtual machine host 140 has a VIA attribute of the thin client 130. Therefore, the connection information can be processed to determine the network connection method used for access by the user 110 for the session.

Similarly, for the configuration shown in FIG. 2E, the network connection method by which the user 110 is able to access the session of the workstations 150, 310 (whether it is accessed locally or remotely), can be determined by VIA attributes resolved from each of the connections 235, 255 and 275.

In one implementation a usage matrix may be used to map data indicative of a session state and a network connection method to at least an occupancy metric. This occupancy metric may be associated with a workstation, which may in turn be mapped to a physical location. As described about, without analysing one or more of a session state and at least one network connection method, the accuracy of device-location mappings may be poor, e.g. may not reflect actual usage and/or occupancy. One example of a usage matrix will now be described. If data indicative of a session state for a workstation is read to be “active”, e.g. a user is logged on and the workstation is unlocked, an occupancy metric may be set to “occupied” or “YES” (indicating occupancy) if the network connection method is at least one of: a console session for a desktop computing device, a virtual machine session through or via a thin client and a remote desktop session via a desktop computing device, wherein the thin client and/or desktop computing device is the workstation in question. For example, these may correspond to the network connection methods shown in FIGS. 1A to 1D, or one or the more complex chained examples shown in FIGS. 2A to 2E, where the workstation in question is one of desktop 120 or thin client 130 used by a user 110. As described previously a network connection method may be set based on a network connection or VIA attribute, which may be resolved iteratively. If data indicative of a session state for a workstation is read to be “active”, e.g. a user is logged on and the workstation is unlocked, an occupancy metric may be set to “not occupied” or “NO” (indicating no occupancy) if the network connection method is at least one used by a remote workstation or home worker, e.g. the workstation in question is being accessed remotely using one of the network connection methods shown in FIGS. 1A, 1C, 1D, 1E, and 2A to 2E. If a data indicative of a session state for a workstation is read to be “idle”, e.g. a user is logged on but the workstation is locked, an occupancy metric may be set to “not occupied” or “NO” (indicating no occupancy) if the network connection method is at least one of: a console session for a desktop computing device, a virtual machine session through or via a thin client, or one used by a remote workstation or home worker. If data indicative of a session state for a workstation is read to be “inactive”, e.g. a user is logged off from all sessions, an occupancy metric may be set to “not occupied” or “NO”. In general these methods analyse one or more network connection sessions to determine a network device that is being physically accessed by a user, e.g. they resolve one or more network connection sessions associated with a first set of network devices to determine a second set of network devices that are physically accessed by a corresponding set of one or more users. Depending on the current state of the network, which may change over time, the second set of network devices may comprises one or more devices from the first set of network devices and/or one or more devices that are not present in the first set of network devices.

In certain examples information for devices and user session information may be gathered from one or more internal and/or external networks, for example by interfacing with the appropriate network management application for each network. In certain examples, the system components described herein may cover one or more internal and/or external networks, in other cases, information may be gathered from a plurality of system components corresponding to each separate network. In this latter case the gathered information may be combined to generated information for devices and user session information for a plurality of internal and/or external networks.

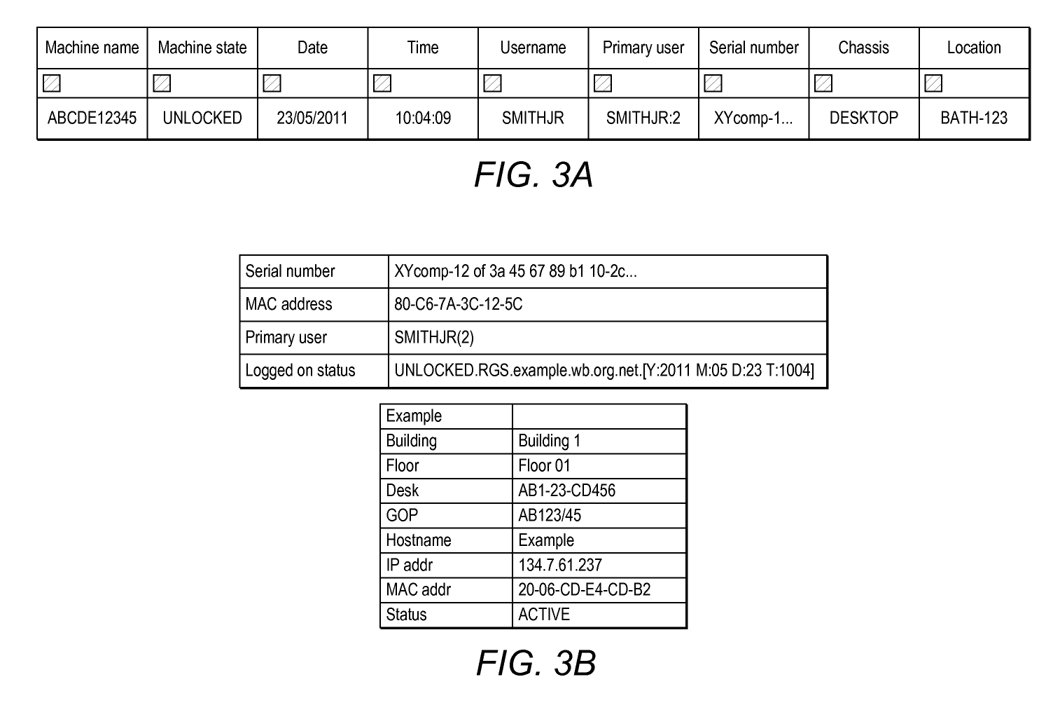

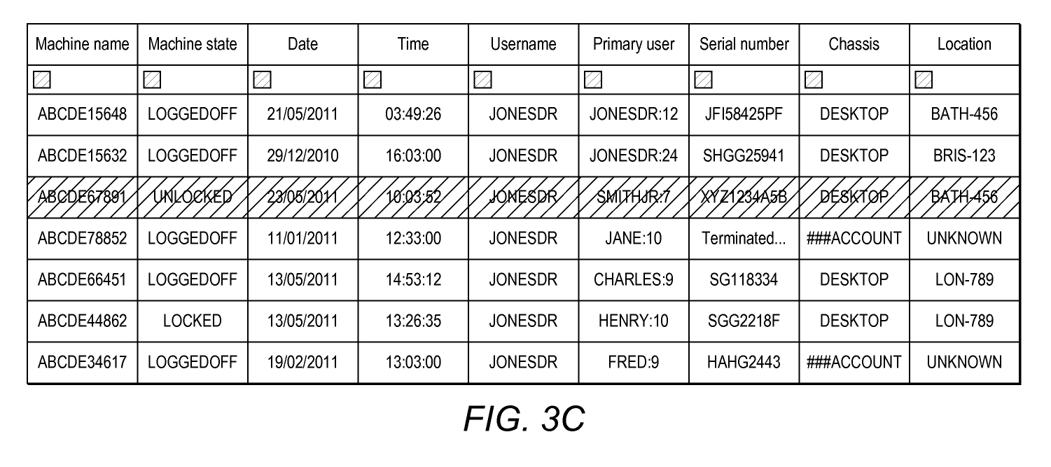

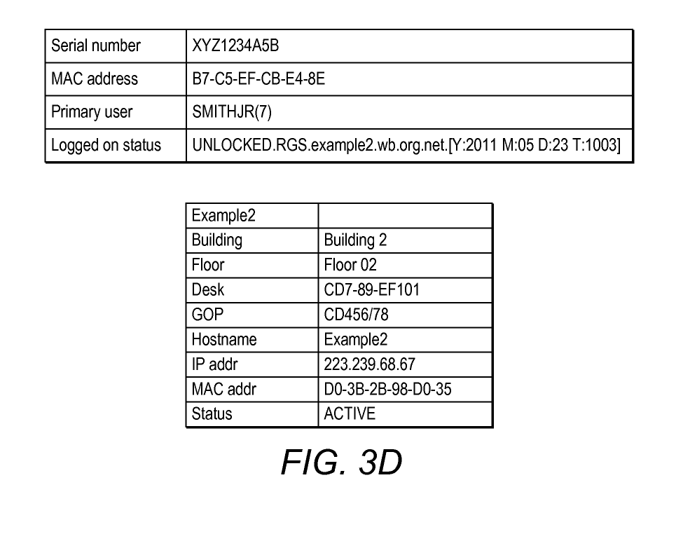

FIGS. 3A to 3D show examples of data that may be used to determine a network connection method. For example, they may comprise representations of display screens from a second component or the like as described herein above and below. It certain cases an integration component may output said data by integrating data provided by at least the first and second components as described herein above and below. FIGS. 3A to 3D demonstrate how a workstation, e.g. a desktop device and/or a thin client, may be resolved based a user's virtual machine session. The workstation may then be mapped to a physical location and used to generate at least one utilisation metric, such as usage and/or occupancy. This is especially useful in large organisation that may have thousands of network devices spread over a series of sites.

FIG. 3A shows a data entry for a particular virtual machine instance. This virtual machine instance has a machine name of “ABCDE12345”. A machine state is recorded as “UNLOCKED”. A date and time of the sample, i.e. the data entry, shown in FIG. 3A is also displayed. A username of a user associated with the virtual machine instance is present—in this case “SMITHJR”. A primary user field is also shown, in this case having a value of “SMITHJR:2”. A primary user may be an additional user in a concurrent session. A serial number is recorded that is an identifier for the virtual machine, in this case “XYcomp-1 . . . ”. The data entry in FIG. 3A has already been correlated with a physical location, for example using a first component as described herein, such that the chassis or device type is identified as “DESKTOP” and the location as “BATH-123”.

FIG. 3B shows further detail for the data entry of FIG. 3A. For example, this detail may be displayed to a user when they click on a graphical control element representing the data entry in FIG. 3A. The data in the upper table of FIG. 3B sets out: the serial number from FIG. 3A in full; a MAC address associated with the virtual machine; a primary user; and a logged on status. The logged in status is “UNLOCKED.RGS.example.wb.org.net.[Y:2011 M:05 D:23 T:1004]”. The logged on status may be used by the system to determine a session state. For example, this data may be parsed and compared with known phrases or variable values to determine a session status. In the example of FIGS. 3A and 3B the session state is logged in and unlocked, logged in being identified by the presence of a primary user and unlocked by the value “UNLOCKED” in the logged on status. The variable value “RGS” indicates a remote graphics session.

The lower table of FIG. 3B shows resolved location information, for example as derived from a first component such as that discussed above. The hostname “example” has been resolved and in this case may refer to a thin client that is displaying the remote graphics session to a user occupying a physical location associated with the thin client. As can be seen the IP and MAC address of the resolved workstation differs from the initial information regarding the virtual machine. A status has also been set as “ACTIVE”, for example according to the rule above as a user is logged in and the workstation is recorded as unlocked. In this case a physical location associated with the thin client may be assigned an “OCCUPIED” occupancy metric value. In FIG. 3B the physical location is desk “AB1-23-CD456” on floor “Floor 01” in building “Building 1”. As described herein a first component may determine a mapping of workstation data, e.g. hostname, IP and/or MAC address (as shown in the lower table of FIG. 3B), to physical location data. The “ACTIVE” status may also be mapped to a “IN USE” usage metric value or alternatively used as-in as a usage metric value.

FIGS. 3C and 3D show another example. In this case, a machine name of “ABCDE67891” represents a thin client workstation brokered to a desktop computing device, e.g. using a remote desktop protocol (RDP) as indicated in the logged in status of FIG. 3D. In this case note that without the system and method described herein, it may be assumed that a physical location associated with the desktop computing device is occupied. However, this is not the case, as shown in the lower table of FIG. 3D the actual workstation that is occupied is hostname “example2” which has a different MAC address and “CHASSIS” value to the recorded session without remote connection resolution.

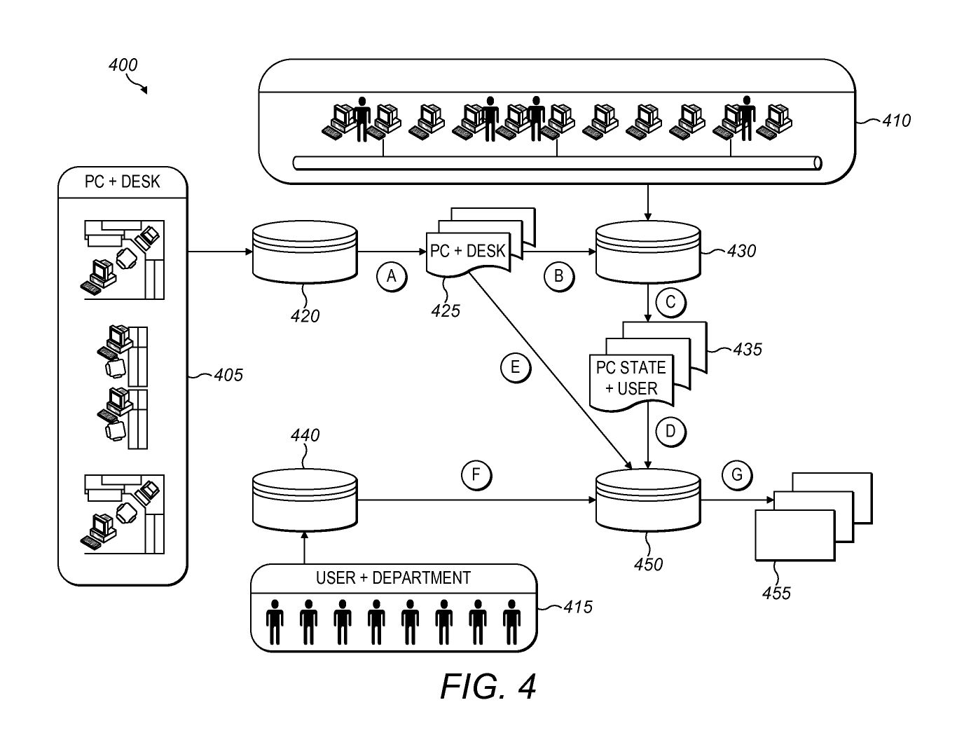

FIG. 4 shows an example of a system 400 for assessing utilisation. Certain components are shown; however, not all components need be supplied in an implementation. Additionally any one component may be adapted to include some or all of the functionality of one or more additional components. A component may also be supplied with one or more physical and/or programmatic interfaces for receiving and/or sending data to one or more other components.

A first component 420 monitors one or more workstations in one or more physical locations. The first component 420 generates data 425 representative of one or more workstation-to-location mappings. For example, the first component 420 may generate a data file, such as a comma separated file. This data file may comprise one or more tuples with a workstation field, as for example identified using a workstation identifier such as a media access control (MAC) address, and a location field, as for example identified with at least a co-ordinate in a co-ordinate system. The co-ordinate system may be a geographical co-ordinate system, for example using a latitude and longitude, and/or a relative co-ordinate system for a building. The latter system may comprise one or more of a floor reference and a co-ordinate from a predefined reference point on the floor, for example a bottom corner. Either co-ordinate system may be used to provide a mapping to a particular area in a building. For example, a particular range of co-ordinates representing a particular area may be mapped to an area identifier. The area identifier may be associated with an area description, for example “touchdown area”, “meeting room” and/or “office”. As such the data file generated by the first component 420 may include a field to indicate if a desk is in a touchdown area, meeting room or office and an export date\time stamp. If a specific building is to be surveyed, then only the workstations located at that site will be provided. Locations may relate to more than one specific building.

In one case the first component 420 uses data indicative of a building infrastructure map. This building infrastructure map may record a location, for example in the form of a co-ordinate, for a particular network socket. The network socket may be mapped to a particular IP address. A workstation plugged into a network socket may be identified by a MAC address/IP address pairing based on data received from the workstation via the network socket, e.g. a mapping of logical layer information to physical layer information.

The first component 420 may implement active network switch polling to permit automated discovery and tracking of all IP devices. This is referred to as a so-called active system. The first component 420 may use intelligent patch panels, i.e. patch panels with additional network functionality, to provide network information regarding network connections from a network switch, through one or more patch panels to a network end point representative of a workstation. In this case “patch” refers to an association with electronic and/or optical patch cables used to connect one electrical device with another for signal routing. For example, a pluggable module may interface with a patch panel and monitor network traffic to determine topology of a network system. Any obtained information may be fed to a system manager application that may form part of, or at least interface with, the first component 420. Similar functionality may also be provided for one or more racks of patch panels, which may utilise a rack manager. A site with these elements provides a highly efficient system for recording network circuit information and for delivering requests for network information directly to one or more patching frames housing network devices such as switches and routers. Even unguided patching tasks may be synchronised back to a system manager application allowing a very high level of confidence in the patching data and hence device location resolution. Active systems provide a very high degree of accuracy of workstation location, for example around 100%.

In certain cases, the first component 420 may use cabling infrastructure information that has documented, for example using network test devices, and entered into a network management computer system. This is referred to as a so-called passive system. This information may include all desk locations with corresponding cabling connections and device resolution. The information may be stored as one or more data files or databases accessible to the first component 420. In some applications, patching from access switches is manually traced. Network devices (e.g. switches and routers) and installed equipment (servers, IP devices or user defined devices) are also identified and logged. This again may involve network switch polling. In certain cases controls are necessary to ensure that accurate records of these network connections are maintained so that workstations are correctly mapped to desk location. This method may be less accurate (˜90-95% than the automated methods described above).

In certain locations, network switches may be monitored at a summary level in order to capture and IP devices coupled to said switches. This is referred to as a so-called summary system. This can be implemented very quickly. In certain cases, resolution of devices to switch port with location may be at floor, department or room level. Lower resolution information, for example at a floor level, may still be useful as it allows as many buildings and sites owned by an organisation to be covered for asset tracking It enables confidence in measurement, e.g. confidence that all devices can be located in some form. It may augment data recorded from a manual workstation to desk audit.

In cases where no fine-resolution patching, cabling or desk information exists a separate record for use by the first component 420 may be maintained. Future information retrieval and network infrastructure upgrades may then allow for this data to be updated and integrated into other pre-existing data records at a higher level of granularity. For example, if a desk-to-workstation map is produced, a network monitoring system may assist in maintaining the accuracy of the data, e.g. to record or alert if any connected devices are moved, as detected by monitoring for changes in switch port. Otherwise, a workstation to desk mapping may be generated based on data recorded via a manual audit.

For network locations that do not have a network monitoring system and/or system manager application in situ, a remote network monitoring system and/or system manager application may be used. For example, a remote system may be allowed Simple Network Management Protocol (SNMP) read access to one or more switches in said network locations. This may then allow the passive and/or summary systems described above to be used for these sites.

For an initial implementation information may be gathered that is representative of one or more physical networks, their topologies and physical layout and cabling infrastructure. This information may comprise communication room configurations and audits, floor layouts and data outlets to desks. This may be used to construct a digital cabling infrastructure database that is used by the first component to perform a workstation-location mapping.

Returning to FIG. 4, the system 400 further comprises a second component 430. The second component 430 manages information for network connections to hosts, as represented by 410. These network connections may be remote network connections. This enables information to be gathered regarding the usage of thin client terminals and/or other devices used for remote connections. This information may not be available to typical network monitoring systems and/or the first component 420. For example, certain network monitoring systems require an application or operating system modification to be installed on a device in order to determine device usage information. However, when using thin clients and/or remote connections a workstation may be run as a terminal only, i.e. it may not be possible to load and run said local application or operating system modification on the workstation.

The second component 430 may comprise an agent to write to, and read from, a network directory service such as Active Directory by Microsoft for Windows domain networks. An analyser, for example a ping or pingless analyser, may be utilised to poll workstations to determine the logged on status of the workstation, which determines whether a machine is in use or not and differentiates between different logon types. The second component 430 may also monitor remote connections to and/or from physical workstations that are running in parallel with local physical access by a user. Without the second component 430 a desk may be erroneously marked as occupied and/or unoccupied, as session information required to determine if a desk is being used is not available.

In the example of FIG. 4, data 425 representative of one or more workstation-to-location mappings is received by the second component 430 from the first component 420. The second component 430 is arranged to correlate workstations identified in said data 425 with workstations used for console sessions or remote connections. For example, the second component 430 may interrogate a directory service for the workstations identified in data 425. As shown in FIG. 4, the second component 430 exports data 435 representative of devices that are being actively used or that have idle sessions. In certain cases, the second component 430 may export a data file, such as a comma separated file, for hosts (i.e. workstations) identified in the data 425 representative of one or more workstation-to-location mappings, providing session information only for users which have active or idle sessions (i.e. a device in an unlocked or locked state). The second component 430 may also export data associated with hosts that are recorded in a network infrastructure but that do not have associated network data (e.g. network devices that are not used indicating that no user occupies a physical location associated with the network device). The data 435 may comprise data records setting out one or more of: a hostname, console or via; a username; a session state; a date\time for session state; location of workstation; and date\time for export.

In certain cases the second component 430 is able to identify and record network connection method and session state information for the following types of host: desktop computers, e.g. physical workstations; virtual machines; laptops; smartphones and/or tablets; home workers using external workstations and/or personal devices.

In FIG. 4, a third component 450 receives data from one or more of the first component 420, the second component 430 and the third component 440 and integrates one or more of data 425, data 435 and data 415 to provide data representative of building utilisation. For example, the third component 450 may import data 435 representative of devices that are being actively used or that have idle sessions and apply one or more algorithms that determine session states, resolve chains of remote connections to console hosts, perform simple counters and/or perform aggregations. Data 425 representative of desk to office mappings may be imported by the third component 450 and matched against the appropriate one or more of data 415 and data 425 from other components. The third component 450 may then generate reports of usage views according to a particular implementation by aggregating all sources of information.

In the example of FIG. 4, a fourth component 440 provides user data 415 that maps a particular user to a particular department. The department may comprise a particular area of a building and/or a grouping of particular user data files.

The operation of the system 400 may be repeated on a periodic basis, for example the frequency for each full cycle to generate output data from the third component 450 can be adjusted according the level of detail required. An example system may have hourly data file exports from the components of the system 400.

In certain examples a data view at path G may be added to allow mapping and display tools to access output data, for example to produce the data shown in FIGS. 5 and 6. In certain cases link F, i.e. between the third component 450 and the fourth component 440 may not be required if a separate application producing the data view has access to the same user and department information. There may also be feedback from a displayed output 455 to the third component 450, such that the output may change dynamic based on user selections.

Output 455 may be text based or graphical depending on requirements. It may provide data indicating one or more of: who is occupying particular work areas; how long is each work area or desk in use every day; where network devices are located and who is using them; and a snapshot of workspace utilisation at any time.

Certain utilisation metrics that may be output comprise one or more of: a percentage time a desk is occupied, which is a measure of the how much time a host was actively used either by duration of sessions or locked\unlocked events; a percentage time a desk is used remotely, which may indicate that a user may be preventing use of a desk when actually located elsewhere; a percentage time a physical location is left idle, which measures when a desk is not actively being used; a percentage time inactive, which measures how often the all workstations at a desk are logged off; a count of users, e.g. how many distinct users share a desk; and a count of departments, e.g. an analysis of usage by department.

FIGS. 5 and 6 show screenshots of an output, for example output 455 generated by system 400. In certain cases, the output may be in the form of a grid or chart format displaying one or more utilisation metrics such as occupancy and usage for one or more physical locations over a time period comprising one or more time sample points. FIG. 5 shows a web-accessible output that overlays one or more utilisation onto a digital representation of a floor plans. A digital representation of a floor plan may be separated into a number of addressable areas. In one case an area of a floor chart graphic may be addressable using a location identifier that is mapped onto a particular pixel range; for example in FIG. 5 each desk in the floor plan may be represented by a rectangle defined by two opposing corner points (X1, Y1) and (X2, Y2). This pixel range may be mapped to a desk identifier as shown in FIGS. 3B and 3D, e.g. “AB1-23-CD456” or “CD7-89-EF101”, for example by a lookup table or equivalent. A colour representative of a utilisation metric may then be assigned to a pixel range based on the utilisation metric value. The utilisation metric may be a statistical metric based on one or more of usage and occupancy, for example a percentage utilisation over a particular time period such as day or hour. It may also be provided for different area sizes, e.g. for zones as well as individual desks. This would be of particular usefulness to identify underutilised areas on a floor by colour coding desks by usage. Department and other data from the third component described herein may be used to filter output data. The data may have a number of hierarchical levels that can be displayed to show utilisation data at different levels of granularity. For example, it may allow output data to be filtered by department, e.g. only show occupancy for IT department, fire and safety zones, e.g. each user may be assigned to a particular fire and safety zone and/or warden and/or administrative groups such as cost centres.

FIG. 6 is a screenshot showing a utilisation metric for the area shown in FIG. 5 at a later point in time following reorganisation of space. For example, FIG. 5 demonstrates that particular areas may benefit from reorganisation. FIG. 6 is colour coded by team, for example different shades of a particular colour may show different utilisation metric values for a particular team.

Certain examples set out herein provide a method and system for real-time monitoring and measurement of the utilisation of space, i.e. a number of physical locations, which can then be used in a number of ways to increase infrastructure efficiency. These examples may also provide the ability to locate all IP devices on one or more networks to assess network capacity management. Certain examples allow searching and exporting of data representative of multiple hostnames that represent actual and virtual network connections.

There are several advantages associated with certain described implementations. For example, the log in details of each user are specific to that user and when the user is logged onto a workstation, it is possible to determine the identity of the user. This can then be correlated with other human resource and device management data, such as a department, a security level etc. This is used in contrast to the use of sensor-based systems; there a user may be granted access based on a ‘swipe’ card or the like, but this requires extra action by a user (and may not be performed in all cases leading to unreliable and inaccurate data). Examples described herein also avoid the need for on-going maintenance such as time needed for changing battery operated sensors, in cards, detectors or optical sensors, for example. It also avoids problems associated with the loss, theft or incorrect usage (e.g. unauthorised lending) of battery operated sensors such as RFIDs. Furthermore, certain examples allow the determination of the type of access and connectivity of the user, such as if a workstation is in use by a home worker on a remote session. Other advantages of certain examples include the elimination of data trigger errors caused by third parties that may include cleaners, maintenance crews, IT support, or other visitors to the desk at which the workstation is located.

Examples of the described system and method have been tested over at least three geographically separate locations, with each location comprising over 2000 desks. Examples are non-obtrusive and secure, residing on one or more local area networks and using network data. The data may indicate details of IP devices on the network, such as those connected: directly, virtually, wirelessly and externally. Using network data network devices can be identified (e.g. desktop, laptop, tablet etc.). It can also be determined how long network devices are connected to the network and whether they are active or on standby.

According to an example, a system for measuring the utilisation of a plurality of physical locations may comprise a first component for mapping data indicative of one or more network devices to data indicative of one or more physical locations in said plurality of physical locations based on network connection data associated with said one or more network devices, a second component for receiving an output of the first component and determining a status of one or more network connection sessions involving said one or more network devices and a third component for receiving an output of at least one of the first component and the second component and outputting a set of utilisation measurements for the plurality of physical locations.

The second component may be arranged to determine a network connection method and a session state for said one or more network devices, the third component being arranged to process data indicative of network connection methods and data indicative of session states for said one or more network devices to generate data indicative of said set of utilisation measurements. A session state may be determined based on network data indicating one or more of a log-in and lock status for a network device. Data indicative of network connection method may involve determining from remote connection data a network device that is being physically accessed by a user. A network connection session may involve a remote network connection. The set of utilisation measurements may comprise at least one of a usage metric and an occupancy metric for each physical location.

In certain examples the system may comprise a database storing data associated with a user of a network, wherein the system is arranged to correlate a user of a network device analysed by at least one of the first component and the second component with data in said database for use in outputting a set of utilisation measurements for the plurality of physical locations. The system may also operate at a predetermined frequency to generate a set of utilisation measurements for the plurality of physical locations over one or more time periods.

According to another example, a computer-implemented method to determine the usage of physical space comprises identifying one or more network devices, for at least one of said one or more identified network devices, determining a network connection method, and determining a session state, processing data indicative of network connection methods and data indicative of session states to generate data indicative of at least one utilisation metric for said at least one identified network device and mapping identification data for said identified network devices to data indicative of one or more physical locations within said physical space, thereby outputting a set of utilisation metrics associated with said one or more physical locations.

The method above may comprise at least one of determining if a network device is being accessed locally by a user and determining if a network device is associated with a remote network connection. Determining a session state comprises at least one of determining a lock status of a network device and determining a log-in status of a network device. Mapping identification data for said identified network devices to data indicative of one or more physical locations may comprise resolving a virtual machine hostname to a network device.

The above embodiments are to be understood as illustrative examples of the invention. Further embodiments of the invention are envisaged. In certain implementations there may be inaccuracies in the manner in which a virtual machine host sets a remote connection (VIA) attribute. To minimise these inaccuracies an automated audit mechanism may be implemented to check that all hosts are compliant with required specifications to ensure correct mapping of virtual hosts to physical device. The term “workstation” has been used herein to refer to any computing device that is connected to a network. The network may be wired and/or wireless and may be based on any suitable physical access medium. A network may comprise a variety of access mechanisms, e.g. some Ethernet and some wireless devices. Certain examples assume that a user can be brokered to only one virtual machine or desktop host at one time. It is also assumed that a user A may log onto a desktop and then lock said desktop; the same or another user may then launch a concurrent remote session to another workstation. In certain cases it may not be possible for a thin client to initiate a concurrent remote session. Some workstations may be provided as ‘network and power’ only devices. These are not connected to monitors and are only accessed remotely. These will always have a remote connection, e.g. VIA, attribute set. In one case, for remote connections, a VIA attribute may be set to indicate that a workstation is being accessed externally, i.e. from an external network. A remote connection may use a Remote Desktop Protocol (RDP), which provides remote connections to hosts. Use may also be made of Remote Graphics Software (RGS), which is a remote desktop connection protocol that may be used for thin client connections to virtual machine hosts. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for measuring the utilization of a plurality of physical locations, the apparatus comprising:
an occupancy processor confiugred to analyze one or more network connection sessions to determine a network device that is being physically accessed by a user;
an interface communicatively coupled to the occupancy processor and configured to receive data indicative of a physical location of said network device, said data being derived from a mapping of data indicative of said network device to the data indicative of the physical location of said network device, said mapping being based on network infrastructure data,
wherein the occupancy processor is further configured to determine at least one occupancy metric for a plurality of physical locations based on the data received from said interface.

2. The apparatus of claim 1, wherein the occupancy processor is further configured to analyze the one or more network connection sessions to determine a session state based on network data indicating one or more of a log-in and lock status for a network device, said session state being used to determine said at least one occupancy metric.

3. The apparatus of claim 1, wherein the occupancy processor is configured to determine the network device that is being physically accessed by the user based on remote connection data.

4. The apparatus of claim 1, the apparatus further comprising:
a database configured to store data associated with the user,
wherein the occupancy processor is configured to correlate the user with data in said database for use in outputting a set of utilization measurements for the plurality of physical locations.

5. The apparatus of claim 1, wherein a network connection session involves a remote network connection.

6. The apparatus of claim 1, wherein the plurality of physical locations are associated with at least one of internal and external areas of at least one building.

7. The apparatus of claim 1, wherein the at least one occupancy metric is used to generate a set of utilization measurements for each physical location.

8. The apparatus of claim 1, wherein the occupancy processor is configured to, at a predetermined frequency, generate a set of utilization measurements for the plurality of physical locations over one or more time periods.

9. A computer-implemented method to determine the usage of a physical space, the method comprising:
identifying a first set of network devices;
resolving a plurality of network connection sessions associated with the first set of network devices, wherein said resolving comprises determining a second set of network devices that are physically accessed by a corresponding plurality of users;
determining a plurality of session states associated with the second set of network devices;
processing at least data indicative of said plurality of session states to generate data indicative of at least one utilization metric for the second set of network devices;
mapping identification data for the second set of network devices to data indicative of one or more physical locations within said physical space, wherein said mapping comprises resolving one or more physical network connections in a network infrastructure; and
integrating said data indicative of at least one utilization metric and said data indicative of one or more physical locations to output a set of utilization metrics associated with said one or more physical locations, said set of utilization metrics corresponding to at least an occupancy of a physical location of the one or more physical locations by one or more users of the plurality of users.

10. The method of claim 9, wherein resolving the plurality of network connection sessions comprises at least one of:
determining if a network device from the first set of network devices is being accessed locally by a user; and
determining if a network device from the first set of network devices is associated with a remote network connection.

11. The method of claim 9, wherein determining the plurality of session states comprises at least one of:
determining a lock status of a network device; and
determining a log-in status of a network device.

12. The method of claim 9, wherein resolving the plurality of network connection sessions comprises resolving a virtual machine hostname to a network device.

13. A system for measuring the utilization of a plurality of physical locations, the system comprising:
a first component for mapping data indicative of one or more network-enabled computing devices to data indicative of one or more physical locations in said plurality of physical locations based on network connection data associated with said one or more network devices;
a second component for receiving an output of the first component and determining a status of one or more network connection sessions involving said one or more network devices; and
a third component for receiving an output of at least one of the first component and the second component and outputting a set of utilization measurements for the plurality of physical locations.

14. The system of claim 13, wherein the second component is configured to analyze at least one of the one or more network connection sessions to determine a session state based on network data for a network device, said session state being used to determine at least one occupancy metric that forms part of the set of utilization measurements.

15. The system according claim 13, wherein the second component is configured to determine, from remote connection data, a network device that is being physically accessed by a user.
